(19) United States
(12) Patent Application Publication
(10) Pub. No.: US 2014/0156344 A1
(43) Pub. Date: Jun. 5, 2014

(54) AUSPICATE SYSTEM AND METHOD

(71) Applicant: EDWIN D'CRUZ, PRINCETON JUNCTION, NJ (US)

(72) Inventor: EDWIN D'CRUZ, PRINCETON JUNCTION, NJ (US)

(21) Appl. No.: 13/921,842

(22) Filed: Jun. 19, 2013

Related U.S. Application Data
(60) Provisional application No. 61/661,558, filed on Jun. 19, 2012.

(51) Int. Cl. G06Q 10/06

(52) U.S. Cl. CPC G06Q 10/063
USPC 705/7.29; 705/7.11

(57) ABSTRACT

Provided is a computerized system and method for performing business analytics and predictive analytics algorithms. The system includes a computer interlace operating on a user's computer device. The computer device includes a processor and associated computer memory, a display and one or more input device. The computer device is in communication with one or more computer database. The processor and memory are configured to provide the interface for the user to access the computer database(s). The processor and memory are configured to perform the steps of accepting input instructions from the input device to access information from one or more database, accepting input from the input device providing instruction to perform business analytics or a predictive analytics algorithm, performing a the business analytics or predictive analytics algorithm, and displaying on the display device the results.

### CROSS REFERENCE TO RELATED APPLICATIONS

This application is related to and claims priority from U.S. Provisional Patent Application No. 61/661,558, filed on Jun. 19, 2012, by Edwin D'Cruz, titled “Auspicate System and Method”, which is incorporated herein by reference in its entirety.

### FIELD OF THE INVENTION

This invention generally relates to a system and method, hereinafter collectively, “the Auspicate”, which allows users to perform business and predictive analytics based on data available in various sources.

### BACKGROUND OF THE INVENTION

The use of business analytics is becoming more prevalent in various industries, as the factors involved are increasingly complex and inter-related. Accuracy of business analytics results is almost always dependent on the accuracy and quantity of the data used. Conventional computerized systems are designed to process numbers from a single data source through various views.

Predictive analytics is a further extension to business analytics, in which the user attempts to predict future performance, prices, or other aspects of a business or industry. Predictive analytics is increasingly important, particularly in industries where business decisions involve very large investments, and therefore also entail great risk, such as the pharmaceutical, and medical industries, and the like. It is difficult for an analyst to draw together multiple data sources, in a reliable and repeatable way, in order to perform consistent predictive analytics, and to allow for consistent improvements over time.

There is also a need for a system and method that supports and allows for multiple database and other information sources to be accessed and used in performing business and/or predictive analytics in a way that allows the analytics to be consistently repeated and improved upon.

### SUMMARY OF THE INTENTION

An aspect of the present invention provides a computerized system and method for performing business analytics. The system includes a computer interface operating on a user's computer device. The computer device includes a processor and associated computer memory, a display and one or more input device. The computer device is in communication with one or more computer database. The processor and memory are configured to provide the interface for the user to access the computer database(s). The processor and memory are configured to perform the steps of accepting input instructions from the input device to access information from one or more database, accepting input from the input device providing instruction to perform business analytics, performing business analytics, and displaying on the display device the results of the performed business analytics.

Another aspect of fee present invention provides a computerized system and method for performing a predictive analytics algorithm. The system includes a computer interface operating on a user's computer device. The computer device includes a processor and associated computer memory, a display and one or more input device. The computer device is in communication with one or more computer database. The processor and memory are configured to provide the interface for the user to access the computer database(s). The processor and memory are configured to perform the steps of accepting input instructions from the input device to access information from one or more database, accepting input from the input device providing Instruction to perform, a predictive analytics algorithm, performing a predictive analytics algorithm, and displaying on the display device the results of the performed predictive analytics algorithm.

In various embodiments of the invention, the predictive analytics algorithm is any of sample sensitivity with coefficient correlation and determination, tree map algorithm, coverage analysis, targeting by payer or plan type, prescriber segmentation, new market segment for existing products, managed care business analysis, market expansion, detail sensitivity with coefficient correlation and determination, and mapping, or the like.

In another aspect of the invention, in the above computerized systems the computer device is a mobile computing device. In various embodiments, the mobile computing device may be a smartphone, a tablet computer, a notebook computer, or the like.

In another aspect of the invention, the computerized system is Internet or Web-based.

### BRIEF DESCRIPTION OF THE DRAWINGS

The novel features believed characteristic of the invention are set forth in the appended claims. The invention itself, however, as well as a best mode of use, further purposes and advantages thereof, will best be understood by reference to the following detailed description of an illustrative embodiment when read in conjunction with the accompanying drawings, where:

FIG. 1 is a schematic depiction of a system, in accordance with an embodiment of the invention.

FIG. 2 is an exemplary process flow that is useful for understanding the invention.

FIG. 3 is an exemplary user interface screen that is useful for understanding the invention.

FIG. 4 is an exemplary process flow that is useful for understanding the invention.

FIG. 5 is an exemplary software architecture, that is useful for understanding the invention.

FIG. 6 is an exemplary client tier that is useful for understanding the invention.

FIG. 7 is an exemplary application tier that is useful for understanding the invention.

FIG. 8 is an exemplary data tier architecture that is useful for understanding the invention.

FIG. 9 is an exemplary user interface display that is useful for understanding the invention.

FIG. 10(a) is an exemplary predictive analytic view that is useful for understanding the invention.

FIG. 10(b) is an exemplary predictive analytic view that is useful for understanding the invention.

FIG. 10(c) is an exemplary predictive analytic view that is useful for understanding the invention.

FIG. 10(d) is an exemplary predictive analytic view that is useful for understanding the invention.

FIG. 10(e) is an exemplary predictive analytic view that is useful for understanding the invention.

FIG. 10(f) is an exemplary predictive analytic view that is useful for understanding the invention.

FIG. 11(a) is an exemplary predictive analytic view that is useful for understanding the invention.

FIG. 11(b) is an exemplary predictive analytic view that is useful for understanding the invention.

FIG. 11(c) is an exemplary predictive analytic view that is useful for understanding the invention.

FIG. 12(a) is an exemplary predictive analytic view that is useful tor understanding the invention.

FIG. 12(b) is an exemplary predictive analytic view that is useful for understanding the invention.

FIG. 13(a) is an exemplary predictive analytic view that is useful for understanding the invention.

FIG. 13(b) is an exemplary predictive analytic view that is useful for understanding the invention.

FIG. 14(a) is an exemplary predictive analytic view that is useful for understanding the invention.

FIG. 14(b) is an exemplary predictive analytic view that is useful for understanding the invention.

FIG. 14(c) is an exemplary predictive analytic view that is useful for understanding the invention.

FIG. 14(d) is an exemplary predictive analytic view that is useful for understanding the invention.

FIG. 14(e) is an exemplary predictive analytic view that is useful for understanding the invention.

FIG. 14(f) is an exemplary predictive analytic view that is useful for understanding the invention.

FIG. 14(g) is an exemplary predictive analytic view that is useful for understanding the invention.

FIG. 15(a) is an exemplary predictive analytic view that is useful for understanding the invention.

FIG. 15(b) is an exemplary predictive analytic view that is useful for understanding the invention.

FIG. 15(c) is an exemplary predictive analytic view that is useful for understanding the invention.

FIG. 15(d) is an exemplary predictive analytic view that is useful for understanding the invention.

FIG. 15(e) is an exemplary predictive analytic view that is useful for understanding the invention.

FIG. 15(f) is an exemplary predictive analytic view that is useful for understanding the invention.

FIG. 16(a) is an exemplary predictive analytic view that is useful for understanding the invention.

FIG. 16(h) is an exemplary predictive analytic view that is useful for understanding the invention.

FIG. 16(c) is an exemplary predictive analytic view that is useful for understanding the invention.

FIG. 16(d) is an exemplary predictive analytic view that is useful for understanding the invention.

FIG. 17(a) is an exemplary predictive analytic view that is useful for understanding the invention.

FIG. 17(b) is an exemplary predictive analytic view that is useful for understanding the invention.

FIG. 18 is an exemplary predictive analytic view that is useful for understanding the invention.

FIG. 19(a) is an exemplary predictive analytic view that is useful for understanding the invention.

FIG. 19(b) is an exemplary predictive analytic view that is useful for understanding the invention.

FIG. 19(c) is an exemplary predictive analytic view that is useful for understanding the invention.

FIG. 20(a) is an exemplary predictive analytic view that is useful for understanding the invention.

FIG. 20(b) is an exemplary predictive analytic view that is useful for understanding the invention.

FIG. 20(e) is an exemplary predictive analytic view that is useful for understanding the invention.

FIG. 20(d) is an exemplary predictive analytic view that is useful for understanding the invention.

FIG. 20(e) is an exemplary predictive analytic view that is useful for understanding the invention.

### DETAILED DESCRIPTION OF THE INVENTION

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention.

The present invention advantageously provides a system and method that supports and allows for multiple database and other information sources to be accessed and used in performing business and/or predictive analytics in a way that allows the analytics to be consistently repeated and improved upon.

The various systems and methods described herein are implemented using one or more computer processor and associated computer memory specially configured to perform the described functionality. In particular, the present invention finds advantageous usage in a multi-processing or multi tasking environment. Persons of skill in the computer arts understand that various alternative processors using various operating systems and memory configurations may be used to implement the systems and methods described.

It is also envisioned that the systems and methods herein described may be provided for distribution on non-transient computer-readable media.

### Exemplary Systems Implementing the Present Invention

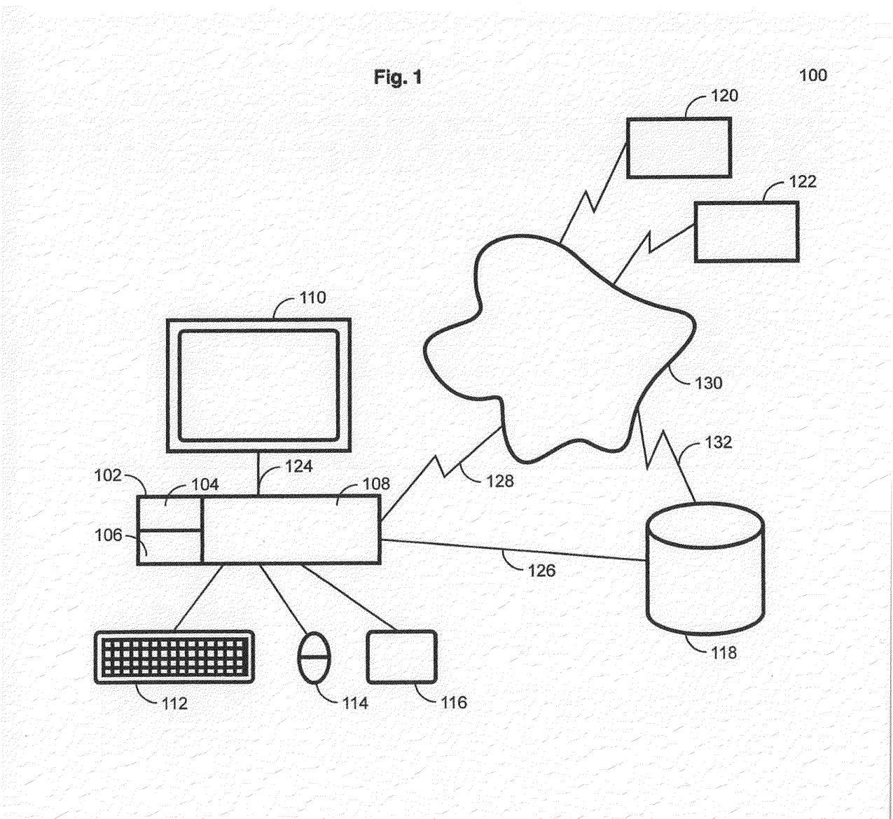

FIG. 1 is a schematic depiction of an exemplary inventive system. In an embodiment of the present invention, a user (not depleted) controls a computer device 102, which, at a minimum, includes a processor 104, associated, electronic memory 106, other interconnected and related electronics 108—e.g., power supply, communication interfaces, input/output devices, etc. The device 102 also controls a display 110 via a display interface 124. The user inputs control information to the device 102 by any of a keyboard 112, mouse 114, stylus pad 116, or any other known user interface or peripheral device in communication with the device 102, without limitation. The device 102 also includes a communications link 126 to at least one database 118. Commutation with the at least one database 118 and with other devices 120, 122 may be via the Internet 130 or other network (not depicted). Any of several various communication interfaces may be used for communication between system components, as is well understood in the computing arts.

In various embodiments, the device 102 processor 104 may a single- or multi-processor or processor array, and may be configured together with the memory to operate any operating system or environment and application program(s), without limitation. Examples of usable devices 102 include, but are not limited to: personal computer, touch device, mobile device, virtual device, online systems, tablets, smartphones, netbooks, notebooks and other computerized systems. Examples of usable operating systems include but are not limited to: Windows, Mac OS, Linux, Android, iOS, WebOS, Symbian, Maemo, MeeGo, and the like. Examples of usable application programs include, but are not limited to:
office applications, e.g., Microsoft Office, Libre Office, IBM Lotus, iWork, etc.;
multimedia applications, e.g., Winamp, Windows Media Player, iTunes, Adobe Flash Player, etc.; and,

browsers, e.g., Mozilla Firefox, Safari, Opera, Microsoft Internet Explorer, Chrome; and other browsers.

An embodiment of the invention uses Microsoft .Net framework 4.0, Silverlight 4.0, Charting-tools (e.g.—Net framework components, Silverlight components+Ajax animation), ADO.Net Entity Framework 4, POCO Entity Generator, Database Support, e.g., SQL Server 2000, SQL Server 2005, SQL Server 2008, Oracle 9i, Oracle 10g Operating Systems—Windows XP, Windows 7 for Development, Windows Server 2003, 2008 for hosting, and any operating system adhering to supported browsers for product users. An exemplary hosting application server is Windows IIS 6.0+.
Browser support requirements include IE 6.0+, FF, Opera, Safari, Chrome

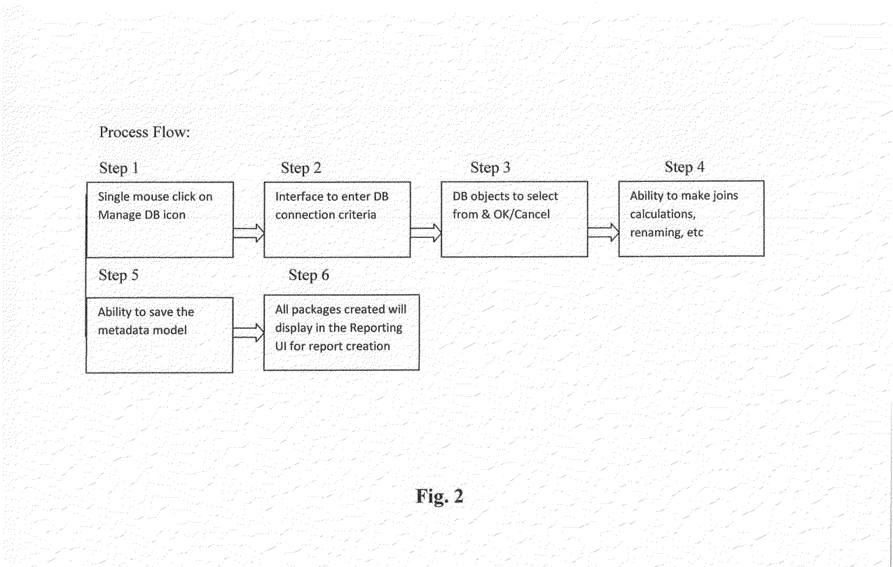

The device 102 implements methods for controlling functions of software applications. Exemplary embodiments of such methods will now be described in relation to FIGS. 2-20

### Exemplary Methods of the Present Invention

The methods of the present invention are described herein with reference to embodiments of the invention referred to as “the Auspicate”. The Auspicate is intended to allow its users to perform Business Analytics as well as Predictive Analytics based on data available in various sources. Various features of the Auspicate will be described herein.

In an embodiment, users will be required to be registered on the system. A web based front end enables users to login to the system. In an embodiment, successful login results in the user being provided with the following options on the User Home page: Manage Database Connections, Manage Data Model i.e. Metadata management, Business Analytics/Business Intelligence and Predictive Analytics. User registration can happen through two channels: Offline—i.e. an administrator creates users using a list that has been provided by a Business team, or the prospective users can send in an e-mail request via a web page. When users enter incorrect login credentials or do not have adequate permissions to access the product website they are redirected, to ‘Unauthorized’ page. This page will have a link to write to the product administrator.

Any user who wishes to access the product site must have an Active Directory account. The product administrator will only pick the specific user(s) and add to roles within the product website. User authentication typically involves several steps, including: Create Users, Authenticate user, Active Directory validation/NT ID, Integrate Single Sign on across systems, and Integration with Firewall and Security.

The Auspicate allows a user to manage database connections. This feature of the Auspicate will enable to create new database connections. Database Connections refer to the channel through which the system “talks” to any database. The connection will fetch database objects for use in Auspicate, the primary input data source. FIG. 2 provides an exemplary process flow for managing databases. The Auspicate shall not store any data within the storage space meant for the application. However, it may cache the data or archive the results of the analysis. It would have the ability to cache data on the DB server, not on the application. This provides enhanced performance with respect to data retrieval. This ability will provide for instant access to most frequently run queries or most frequently accessed data.

Selecting the Manage Database connection also provides further options, such as create data connection, edit data connection or delete data connection. In create data connection, a new connection to typical RDBMS can be created by specifying a connection name, database server name, user name and password. An option to save password or otherwise is required. A drop down to select the database type (viz. SQL Server, Oracle etc.) is also required. A connection to flat file can be created by specifying connection name, file location (Password protected files cannot be supported). In case of CSV, TXT files the users will be required to specify only one type of delimiter character. A single product user can create several (database or flat file) connections. Multiple connections can be created on the same database or flat file. A connection created by one user can be shared across other product users. The ability to connect to password protected Microsoft Excel files is also provided. In edit connection, connection properties, such as, but not limited to, the connection name itself, server name, user name or password, may be edited.

For deleting connections, the user may wish to delete any existing connection. The user should be warned about the potential error in generating any reports that may depend on the connection being deleted. To assist with this, a list of items (such as reports, other users, packages etc.) that are currently dependent on the connection may be displayed.

All activities performed in management of databases should be tracked. This information will be available only to the Administrator users via the Audit page. The ‘Audit’ shall capture the following fields whenever there is a user activity: User Name, Action, Date, Time Stamp, and Comments (optional if created or edited, mandatory for deletion).

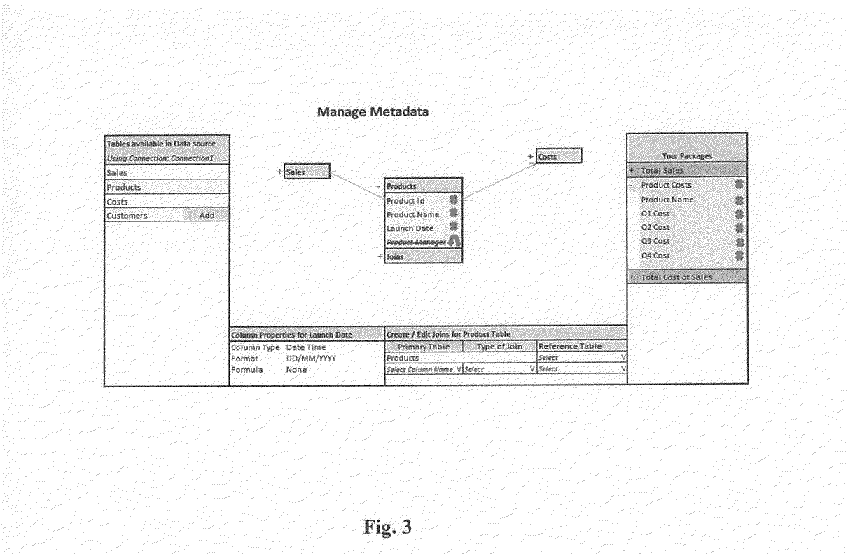

The user is also able to manage their Data Model and Metadata. This allows them to create a data model based on the available connections. The Data model defines the scope of analysis of the source database. The data model will be responsible to ensure the format of data. While creating a data model, users will be allowed to select all or certain components of the source database. The virtual data model will be persisted in Auspicate as metadata. Several features of data modeling include: Start by creating new data model; Create Business Views; Manipulate relationships, establish cardinality (1:1; 1:many; Many:Many); Enable ability to drill down hierarchies (e.g., ProductGroup:Product:Package) OR CustomerGrouP:CustomerType:Customer—This provides ability to create aggregates at all levels of hierarchy; Refresh existing data model—useful if the source database schema has changed recently; Edit data model; Automatically pull through related tables; Create Joins—Inner Join, Outer Join, Complex Join, Any other Joins; Create User defined objects,—provide ability to manipulate data for use downstream—DB Functions (these functions can be reused at Step 4 below of Business Analytics), Calculations, Conditions, Filters; and Modify physical DB object names to business names. An exemplary metadata management screen is provided as FIG. 3.

In an embodiment a data modeling module provides users with the ability to create data models. The data modeling module provides the user with capabilities to enhance the existing data model and improve performance. The user is able to create database objects like aggregate tables and materialized views. This further enhances the use of tables and views, which is particularly useful in later phases, and provide full data modeling capabilities. To begin with, the module will provide the following functions: Creation of Aggregates—Based on attribute selection, create an aggregate table on DB; and, Creation of materialized views—same as aggregate table creation.

The Auspicate also provides business analytics, to enable business users to perform source data analysis through the available data models. Available. Users may be required to feed the analysis instructions into the system, such as to generate trends, etc.

A typical business analytics process involves the following steps:
User interface provides a model on the display
User double clicks on each required element
Selected reporting elements are displayed on right side of screen
User interface provided to perform calculations, use functions etc. to manipulate the data
Report can be formatted—drag, drop and reorder elements
Column and filter data are selected, group, sort, ascending or descending.
Option to “Run” report is provided
Clicking on “Run” will submit query to DB and retrieve first 100 rows
Paging facility available to page down and up for data viewing
Dynamic data displays are enabled—list, crosstab, various types of charts, graphs, maps
Feature/User interface screen is provided to edit SQL (SQL will be generated based on columns selections)
Ability for user to write nested sub-queries (based on user selection criteria) provided
Storage of frequently run queries for fast retrieval—e.g., database/app server cache
Ability for user to search. E.g., search for Customer should retrieve Customer data (DB-query) provided
Options to search by Customer, Products, Sales, Employee, or the like provided
Ability to create Aggregates (tables) and link them to descriptive data (qualitative data)
Ability to create Materialized Views

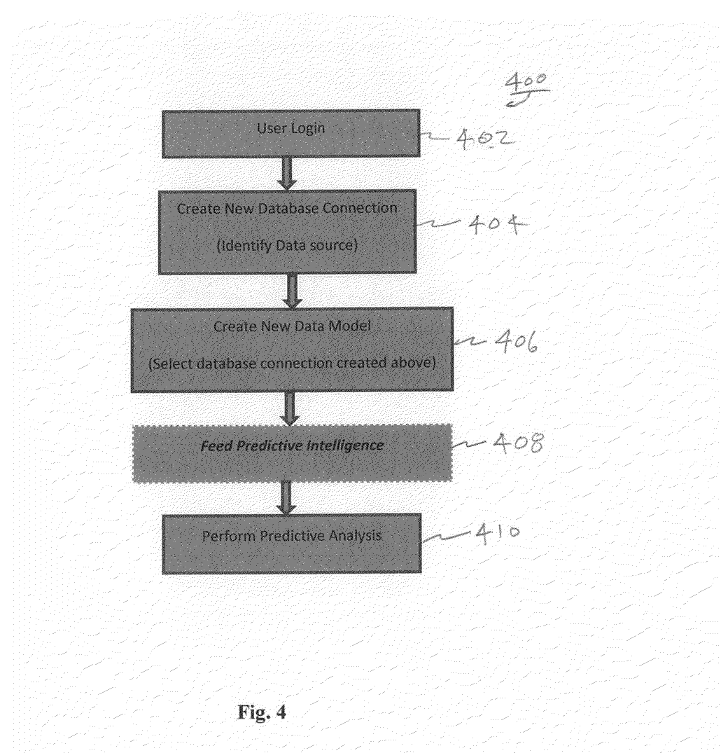

In an embodiment, the Auspicate also provides for predictive analytics. In predictive analytics, users with special permissions to are allowed to register/create new users. They may also manage user permissions. Thereafter, the process of performing predictive analytics algorithms generally entails the steps 400 shown in FIG. 4. The user logs in at step 402, and creates a new database connection, which may also entail identifying data sources at step 404. Next, using the created database connection, a new data model is created at step 406. Predictive intelligence is then fed into the system at step 408, and one or more predictive analytics algorithm is performed at step 410.

FIG. 5 depicts an exemplary software architecture 500 for the Auspicate. The major software components and their interaction at a high level are: the client tier 502, the application tier 504, and the data tier 506. This architecture isolates all major functions of the product. For example, the report presentation is independent of the business logic and this in turn is isolated from the data abstraction.

The client tier 502—also known as Presentation, UI, etc.—provides product users with a graphical user interlace, which allows interacting with the system. Users can create data connections, create and format reports from their desktop machines. Technically, the client tier 502 basically accepts requests and passes to the next tier, waits for result and displays these back to the user.

The application tier 504 accepts instructions from the client tier 502, and coordinates the application activity. The application tier 504 consists of business logic and other processing components. Business logic components receive the requests from the client tier 502 and process the instructions that are coded previously, such as business rules and other calculations. The business logic may in turn make calls to the processing logic, and in such a case the processing logic will only behave as helpers. The processing logic components either receive requests from the client tier 502 directly or via the business logic components. For example, during user authentication, client components may call processing logic directly. When a user requests a report the call passes from client to business logic first, which in turn calls the data abstraction engine to get report data.

The data tier 506 is the database server that stores the product data. The data tier 506, based on the request from connection engines of the application, provides connectivity to the data source. The data source could be any of the following—relational database, data warehouse and other flat files, or the like. Should there be a need for the product to maintain a database, the architecture permits that.

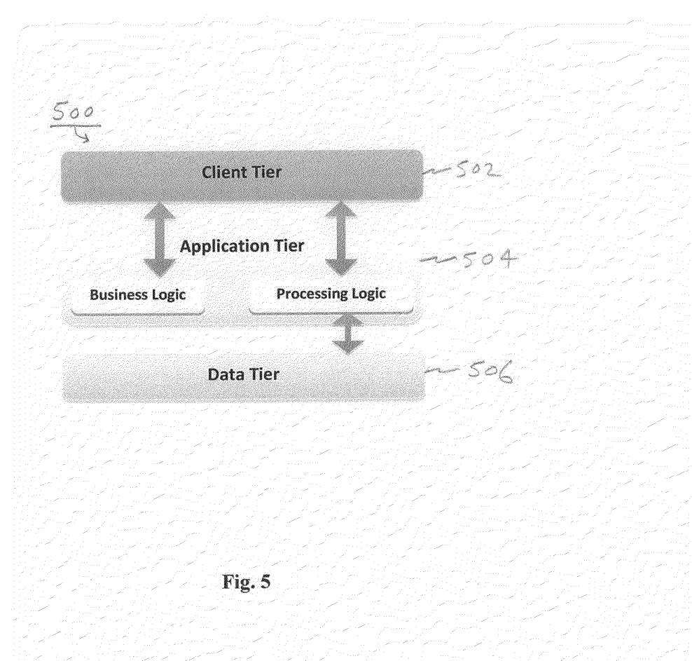

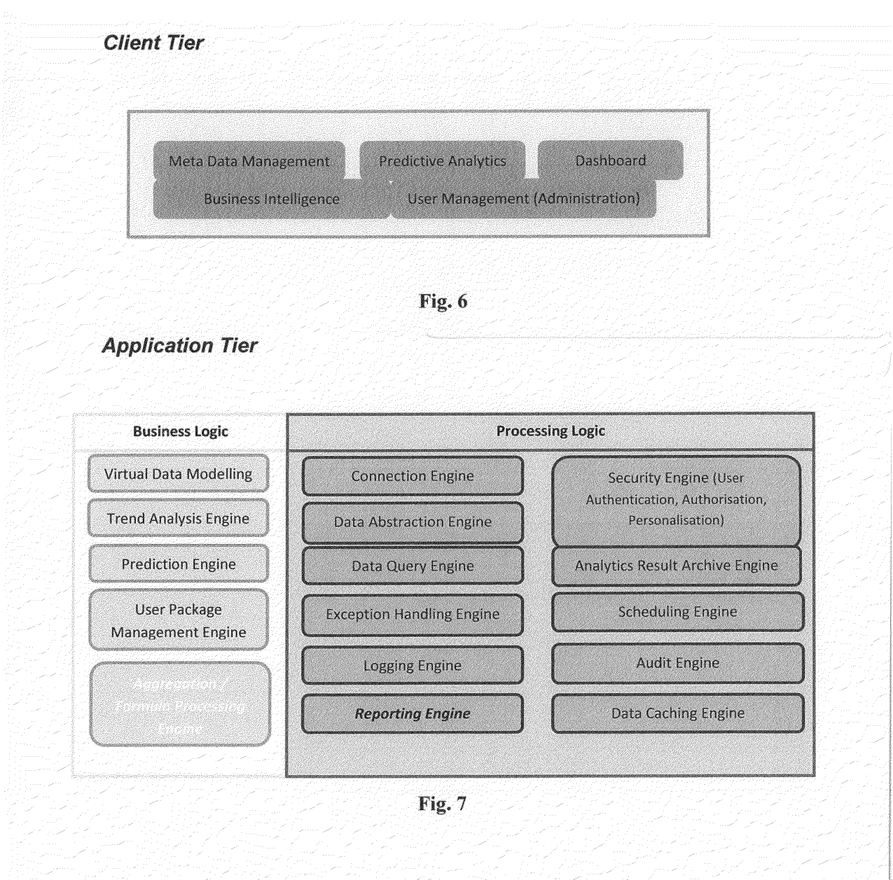

FIG. 6 presents a more detailed client tier 600 in an embodiment of the invention. This client tier is responsible for providing user with a web based interface to interact with the system. End user input validations performed in in this tier. In one embodiment this tier is a website built using Microsoft ASP.Net.

FIG. 7 presents a more detailed application tier 700 in an embodiment of the invention. The application tier 700 includes a connection engine, which enables users to create various connections to the database of their choice. Multiple database connections are possible and may be required to be active at the same time. Also included is virtual data modeling, which allows the creation of a data model on top of the source database. This is particularly useful for building a virtual data mart, data warehouse where the source database is de-normalized. The keyword ‘virtual’ simply means this is not a data store.

Also in the application tier is a data abstraction engine, which provides a data abstraction layer. This layer is a proxy between the virtual data model and the data in the source database. A data query engine is also included, which generates queries to fetch data from the source database based on the virtual data model, and also may perform data merging, look up, and the like, as well as a data caching engine, built for example using the caching application block of the Microsoft Enterprise library 5.0. It supports both an in-memory cache and, optionally, a hacking store that can either be the database store or isolated storage. An exception handling engine, logging engine and security engine are also provided in the application tier.

FIG. 8 presents a data tier architecture 800 in an embodiment of the invention. In this architecture 800, business analytics reports of data, for example, may be generated by the user selecting report fields and running a report, which results in the intelligent query builder creating one or more database queries to create a user-defined view. The data is then accessed, such as from an SQL database or flat file.

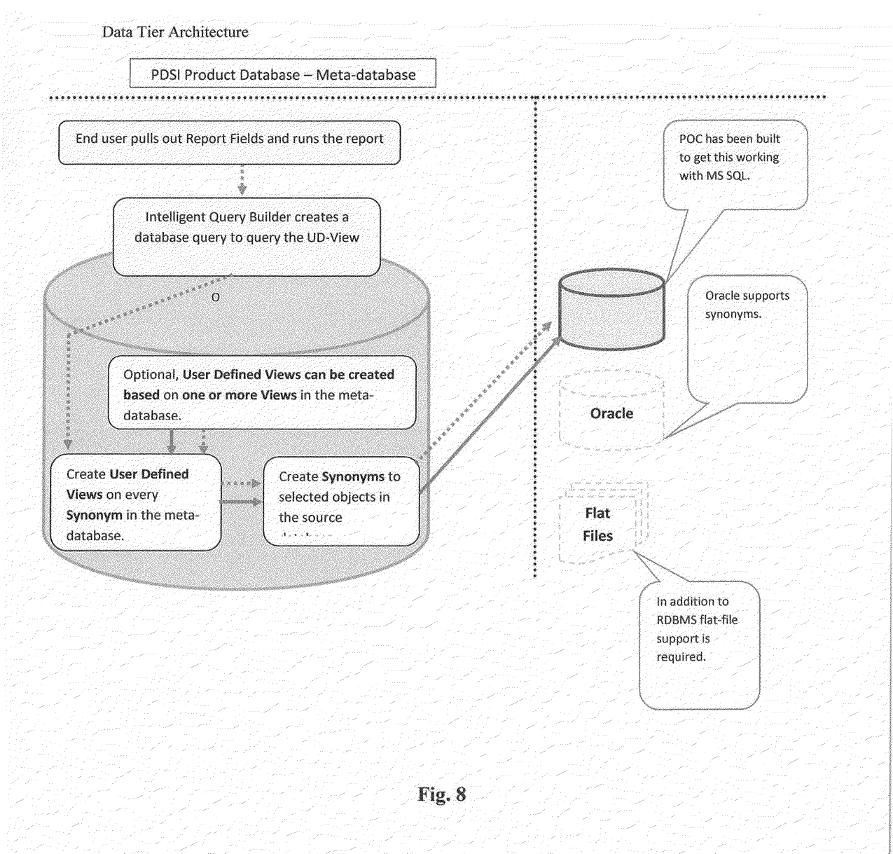

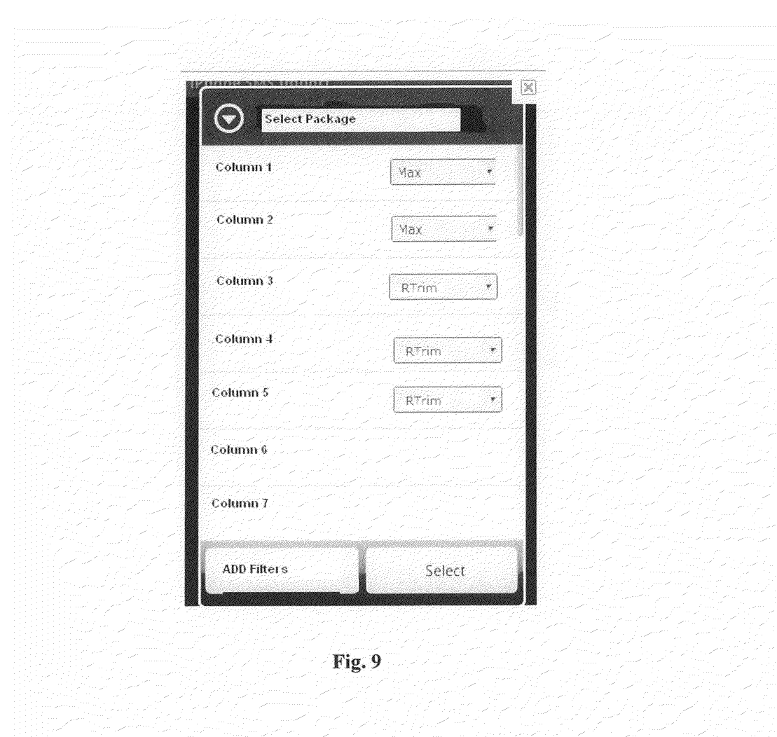

FIG. 9 presents an exemplary user interface 900 for package selection in an embodiment of the invention. Once the user selects Build New Query option, they are shown a page listing all the packages in a drop down that he had created on their account and saved. On selection of the required package, all the package fields will be displayed. These fields will be segregated depending on the table they belong to, like on the standard reporting page of desktop application. The user will then need to check the fields required for their query.

Once the fields/columns to be queried upon are selected and submitted, a screen (not depicted) for building complex queries will be displayed. On this screen the user can add functions and attach filters to columns and submit the query to the database. Query results are then to the user on a grid or plotted on graphs.

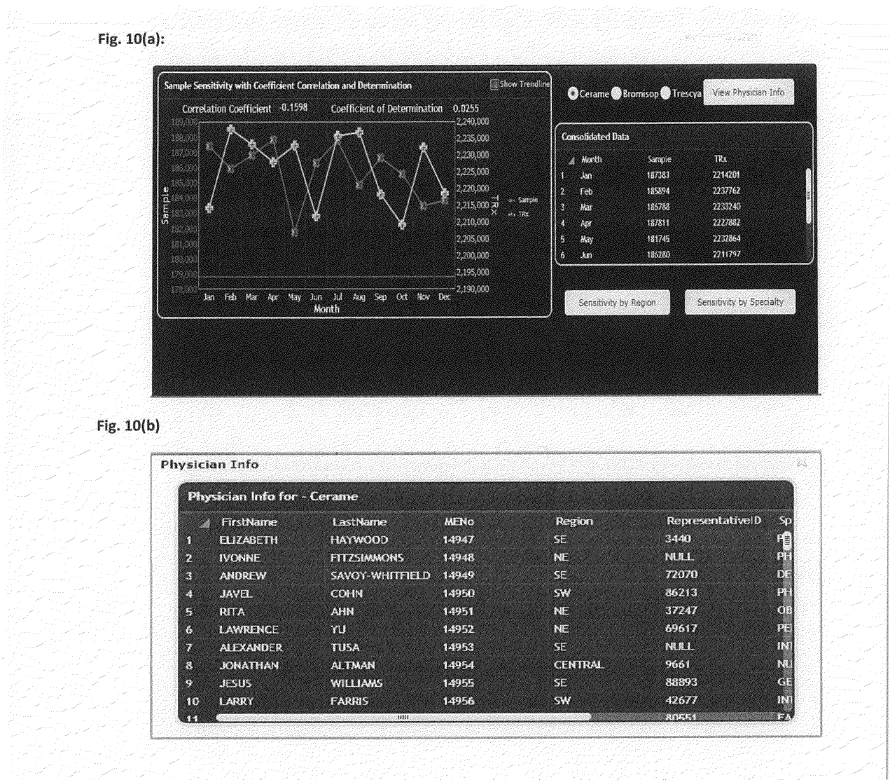

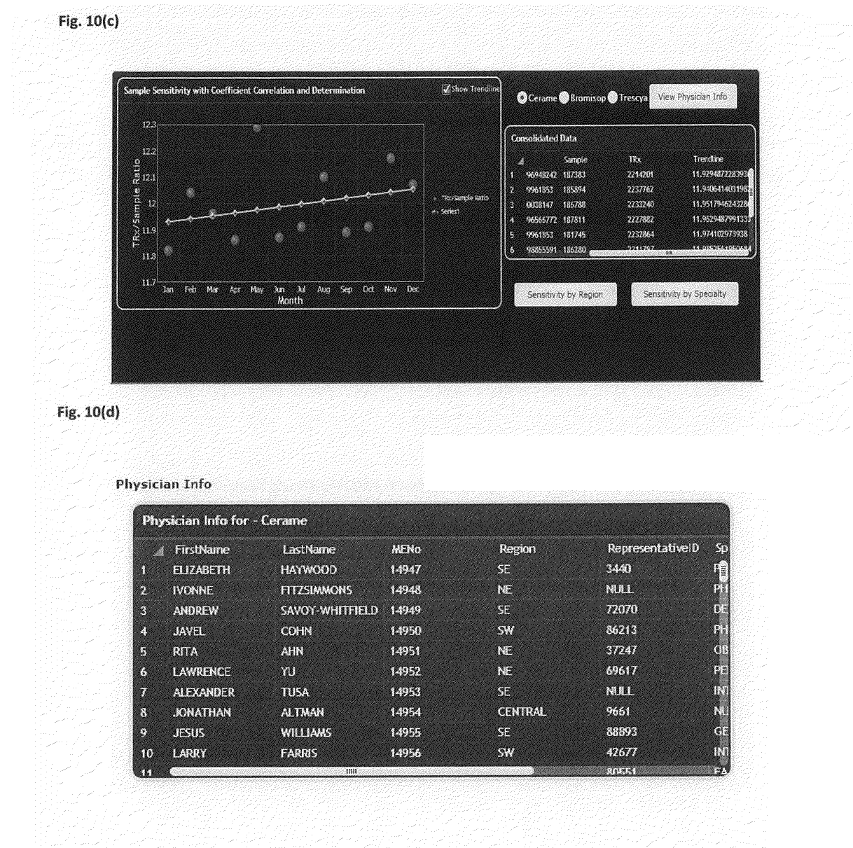

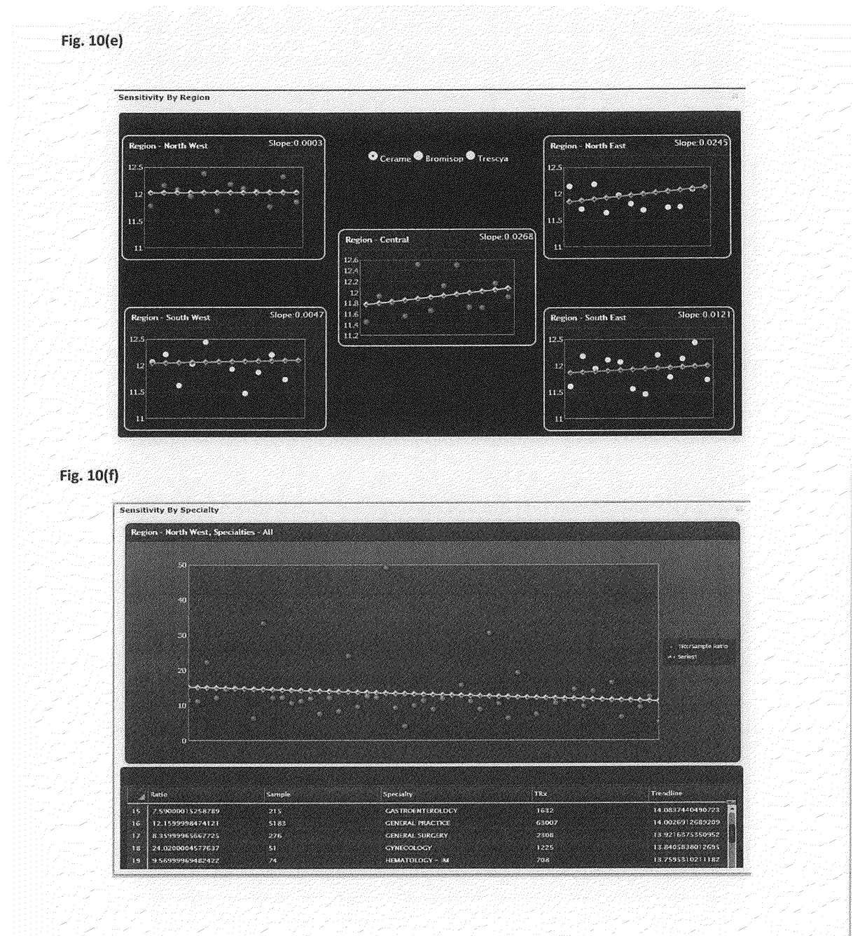

FIGS. 10-20 depict various user interface displays related to various predictive analytics algorithms.

FIGS. 10(a)-10(f) are exemplary views depicting the predictive analytic algorithm of sample sensitivity with coefficient correlation and determination. This algorithm explains the calculation of the coefficient of determination and correlation coefficient for sample and TRx. In FIG. 10(a), a graph is displayed with Months on the X-axis and Sample, TRx on Y-axis and also displayed is the correlation coefficient and coefficient of determination values. The “Show Trend line” check box will show/Hide the Trend line. Also displayed is the consolidated data for Month wise Sample and TRx values.

FIG. 10(b) is generated by the user clicking on the provided View Physician Info button and selecting a product from the product option menu will list Physician Info details in a grid format.

The show trend line check box displays the trend line for TRx/Sample Ratio, as presented, in FIG. 10(c). A graph is displayed with Months on the X-axis and TRx/Sample ratio on the Y-axis. And also displays the consolidated data for Trend line

In FIG. 10(d), the user has clicked on the “View Physician Info” button and selecting a product from the product option menu will list Physician Info details in a grid format.

Upon clicking on the “Sensitivity by region” button, as shown in FIG. 10(e), the trend lines and Slope values for each of the regions—NW, NE, CENTRAL, SW, SE are displayed in a separate window for the selected product.

When the “Sensitivity by Specialty” button is selected, the trend line for all specialties in the region which has negative slope value and also the corresponding data on the grid is displayed, as presented in FIG. 10(f).

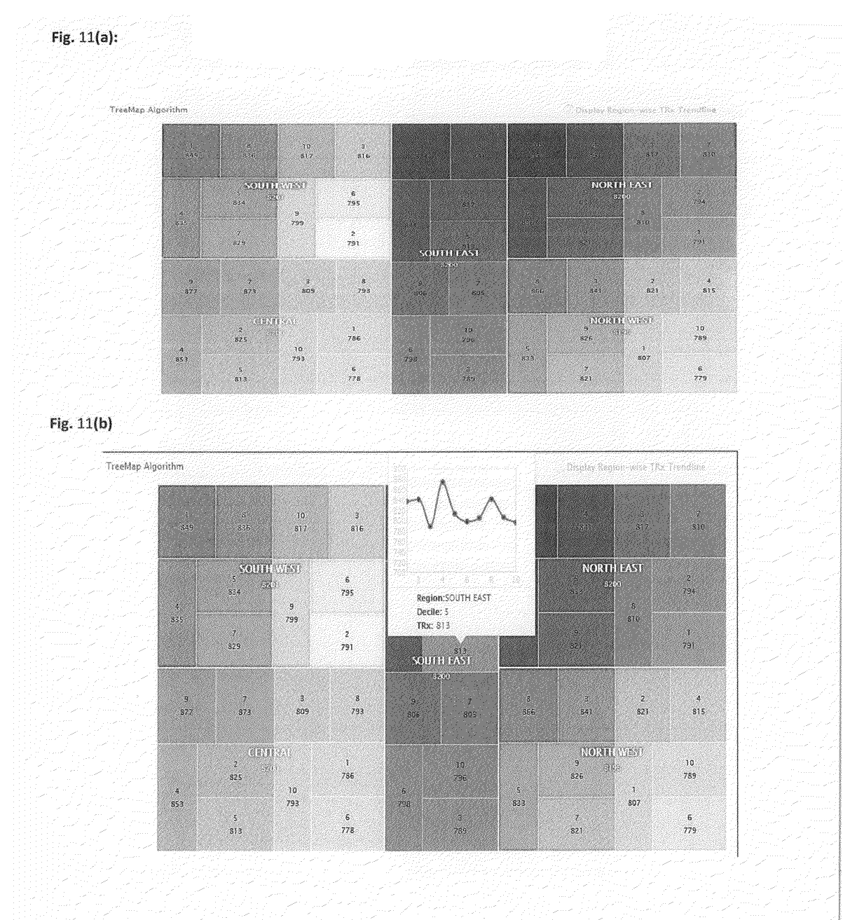

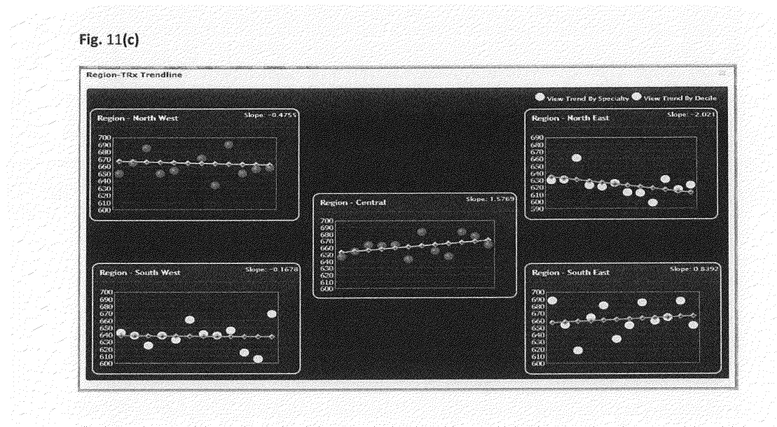

FIGS. 11(a)-11(c) are exemplary views depicting the tree map predictive analytic algorithm. In this algorithm, as presented in FIG. 11(a), the tree map for the US Regions i.e., NB, NW, CENTRAL, SB, SW is displayed, with Decile-TRx in each region on a tree map. Moving the mouse over on each region displays a line chart with Decile to TRx, where Decile is plotted on the X-axis and TRx on the Y-Axis, as shown in FIG. 11(b). FIG. 11(c) depicts the display when the “Display Region-Wise TRx Trendline” radio button is selected, which shows the trendline with the slope value for the TRx in each region. For the regions which have a negative slope value and a declining trend, the trend by specialty and trend by decile are displayed.

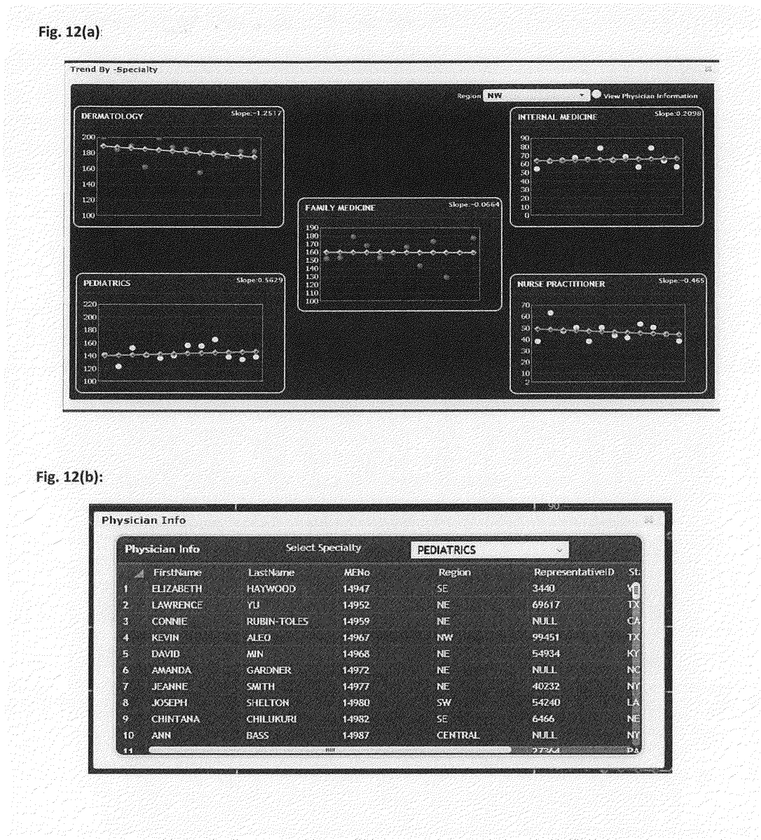

FIGS. 12(a)-12(b) are exemplary views depicting the trend by specialties predictive analytic algorithm. in FIG. 12 (a), various specialties are presented for a region, for example, DERMATOLOGY, INTERNAL MEDICINE, FAMILY MEDICINE, PEDIATRICS, and NURSE PRACTITIONER. Upon selection of a specially, the user is presented with more detailed physician data, as depicted in FIG. 12(b).

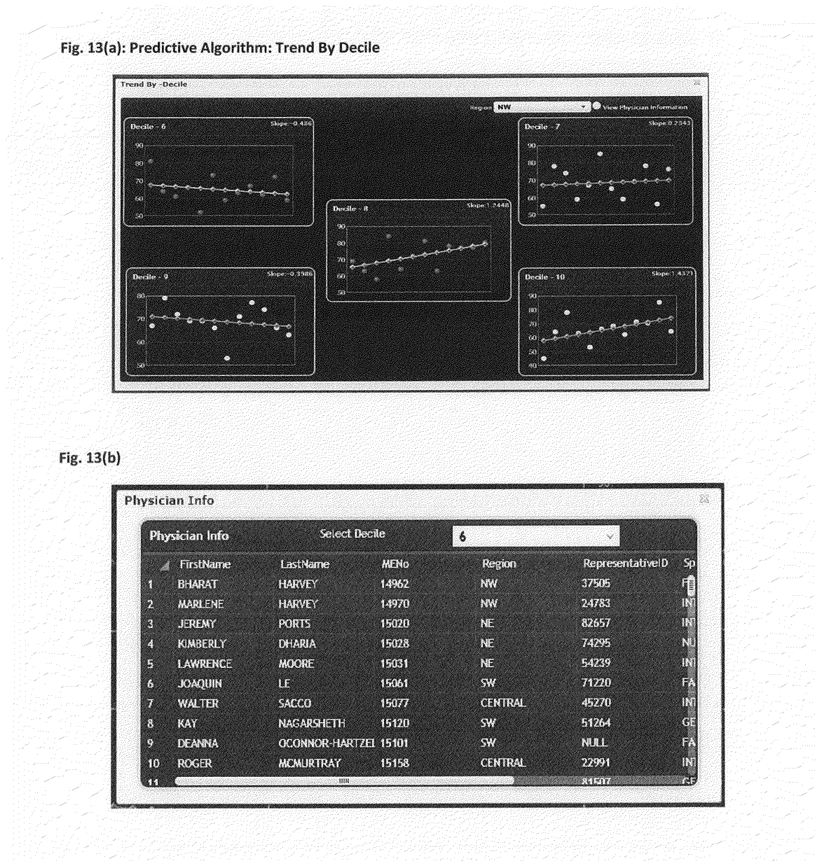

FIGS. 13(a)-13(b) are exemplary views depicting the trend by decile predictive analytic algorithm. As shown in FIG. 13(a), selecting the region from the dropdown will display the trend for the decile. Clicking on the “View Physician Information” displays the list of physicians for the selected decile, as shown in FIG. 13(b).

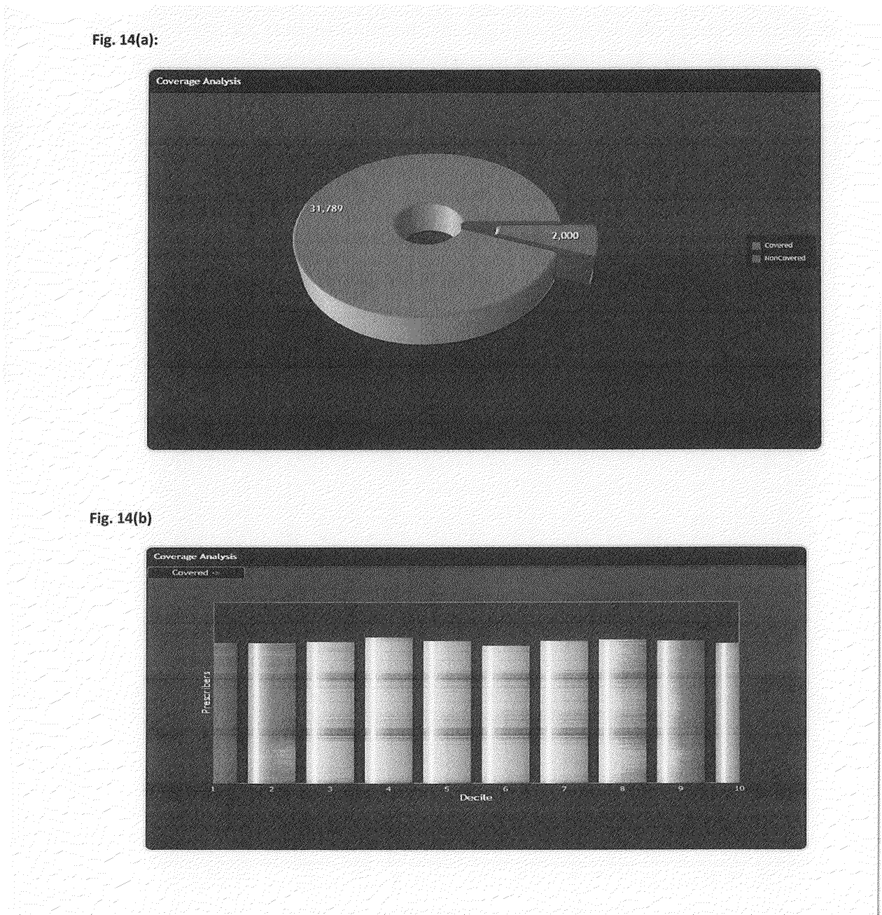

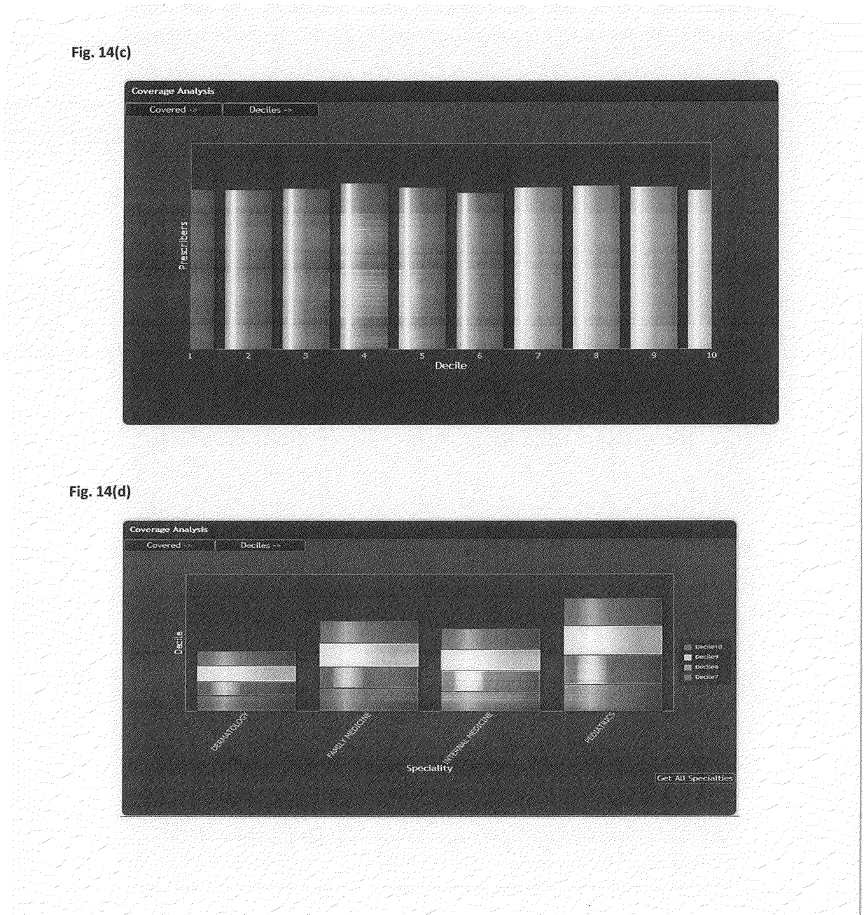

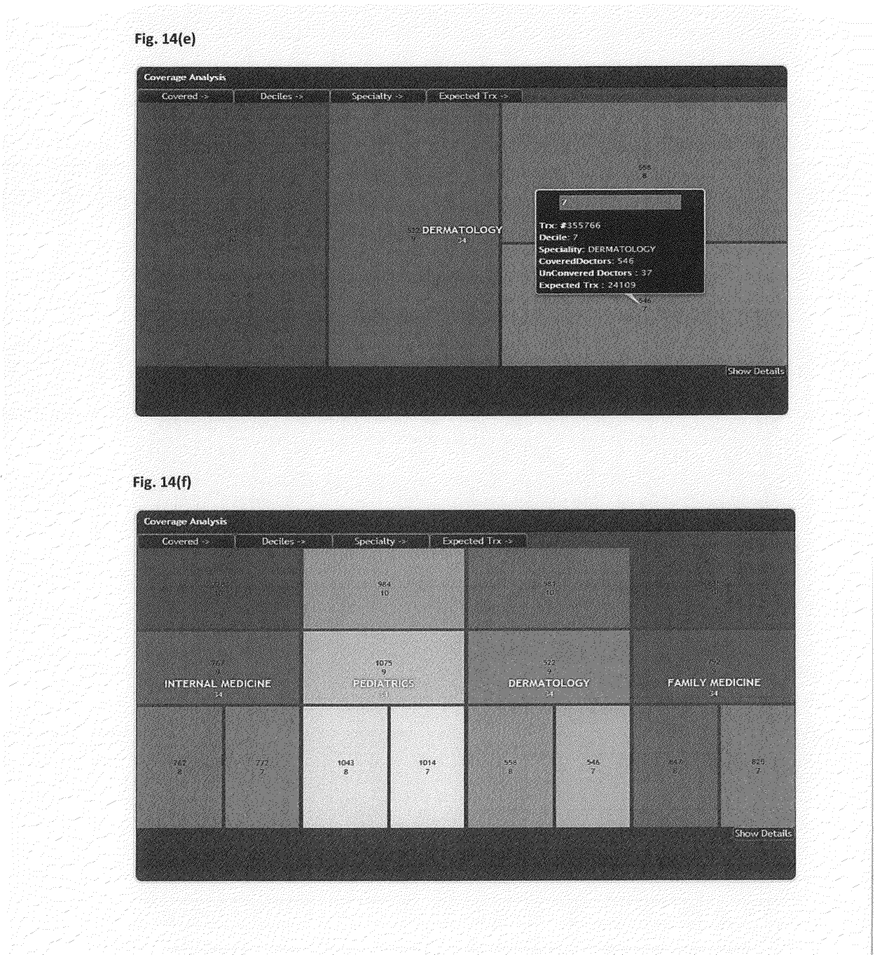

FIGS. 14(a)-14(g) are exemplary views depicting the coverage analysts predictive analytic algorithm. Coverage analysis is an algorithm that denotes the number of prescribes covered and non-covered by a sales representative. It starts with a pie-chart, such as in FIG. 14(a), which has covered and uncovered slices. Clicking on the covered slice in the chart causes the display of the number of prescriber by their deciles in a bar chart, as shown in FIG. 14(b) and FIG. 14(c). Stacked bar charts with specialties on X-axis and deciles on Y-axis, such as in FIG. 14(d), are produced by selecting, for example, 7, 8, 9, 10 deciles bars.

Upon selecting any of the stacked bars a tree map is displayed, such as in FIG. 14(e), with expected TRx with that selected specialty. Clicking on the “Get All Specialty” button will calculate and display the expected TRx for all the specialties, as shown in FIG. 14(f). Clicking on the “Show Details” button in the tree map will list expected TRx, and the number of doctors of the covered area in a grid format as shown in FIG. 14(g).

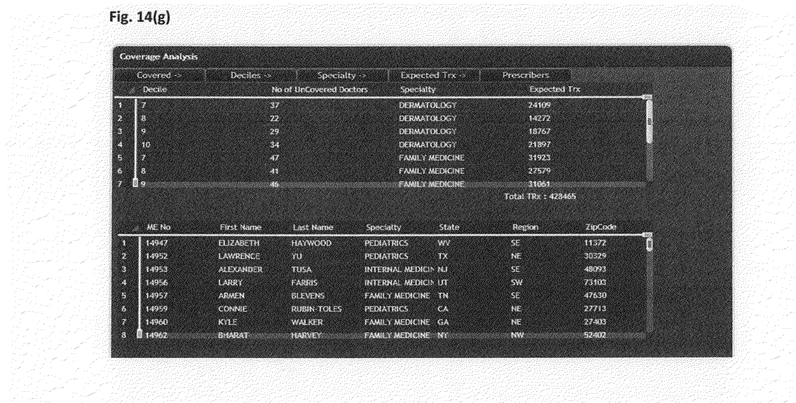

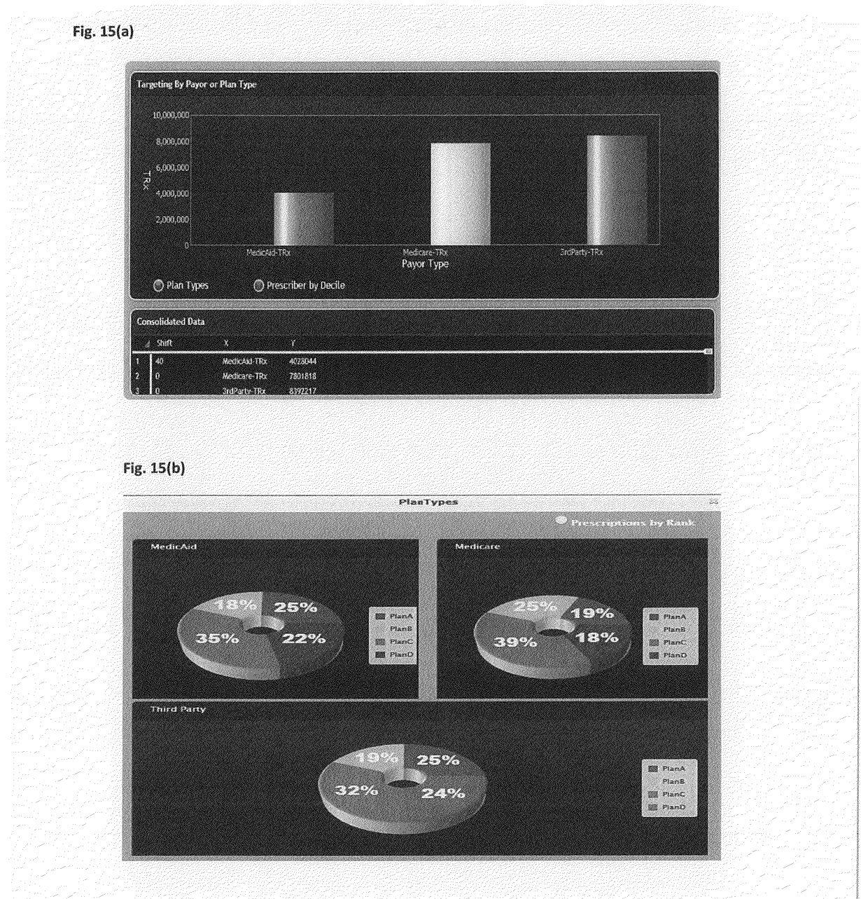

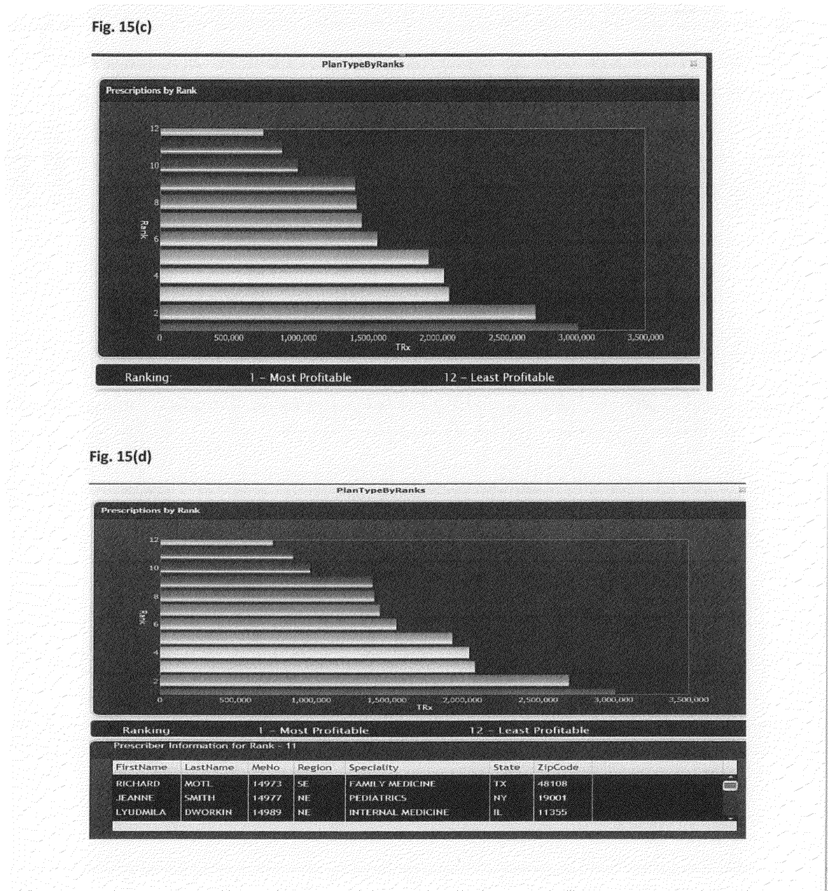

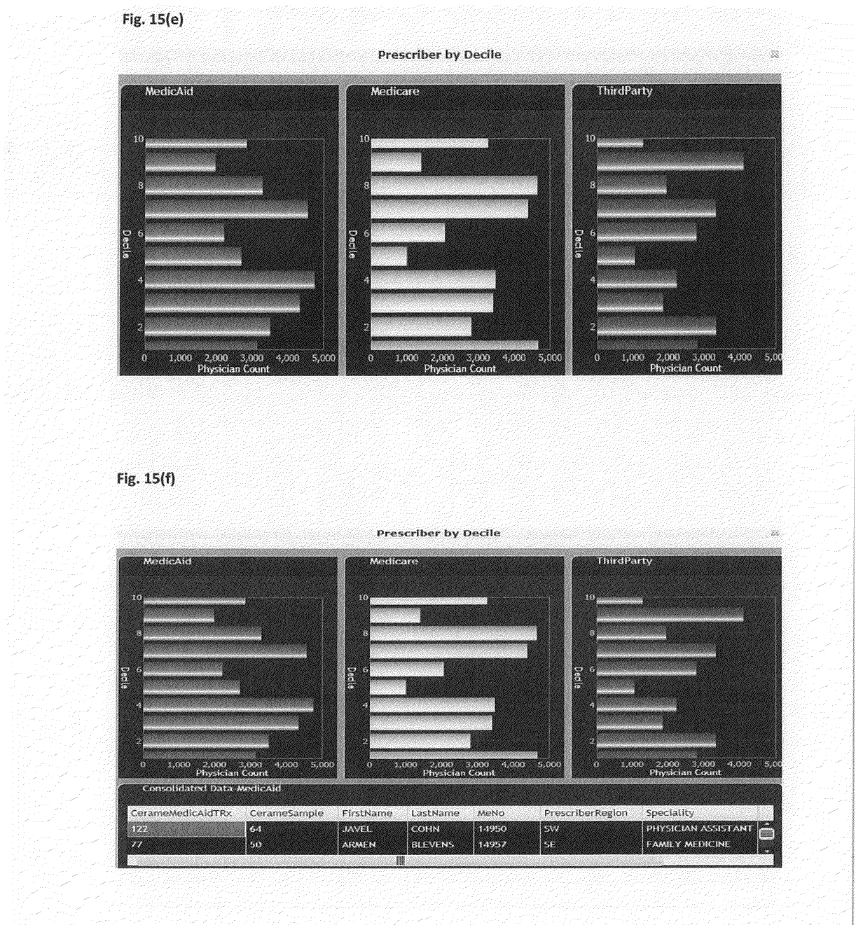

FIGS. 15(a)-15(f) are exemplary views depicting the targeting by payer or plan type predictive analytic algorithm. This algorithm describes the TRx by Payer types, as depicted in FIG. 15(a). There are two types of payer types: Managed and Un-managed. Managed payer types include: Medicaid, Medicare, and Third Party. Un-managed payer type includes Cash. The Managed payer types are bound to the bar chart with Payer types on X-axis and TRx on Y-axis and also displayed are consolidated data for the payer Types and TRx in a grid.

Upon selecting the “Plan Types” radio button, pie charts for Medicaid, Medicare, Third Party are displayed with the percentage of the TRx for the plan types A,B,C,D, as shown in FIG. 15(b). Upon selecting the “Prescriptions by Rank” radio button, a histogram with total number of prescriptions in a particular rank (from 1 to 12), where rank 1 being most profitable and 12 being least profitable, is displayed, as shown in FIG. 15(c). By clicking on the bar with particular rank, the Prescriber's information in that rank is displayed, as shown in FIG. 15(d).

Upon selecting the “Prescriber By Decile” radio button, histograms for MedicAid, Medicare, Third Party, with physician count on X-Axis and deciles (from 1-10) on Y-Axis is displayed, as shown in FIG. 15(e). Upon clicking, on the bar with a decile on the histogram, the data of the prescribers present in that decile are displayed, as shown in FIG. 15(f).

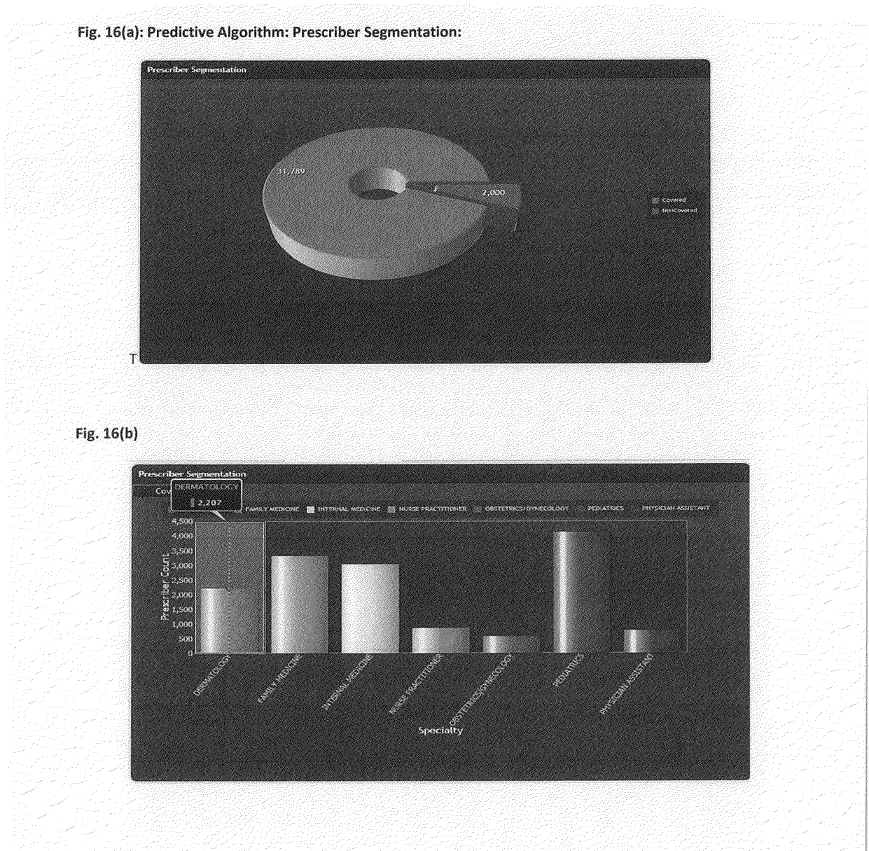

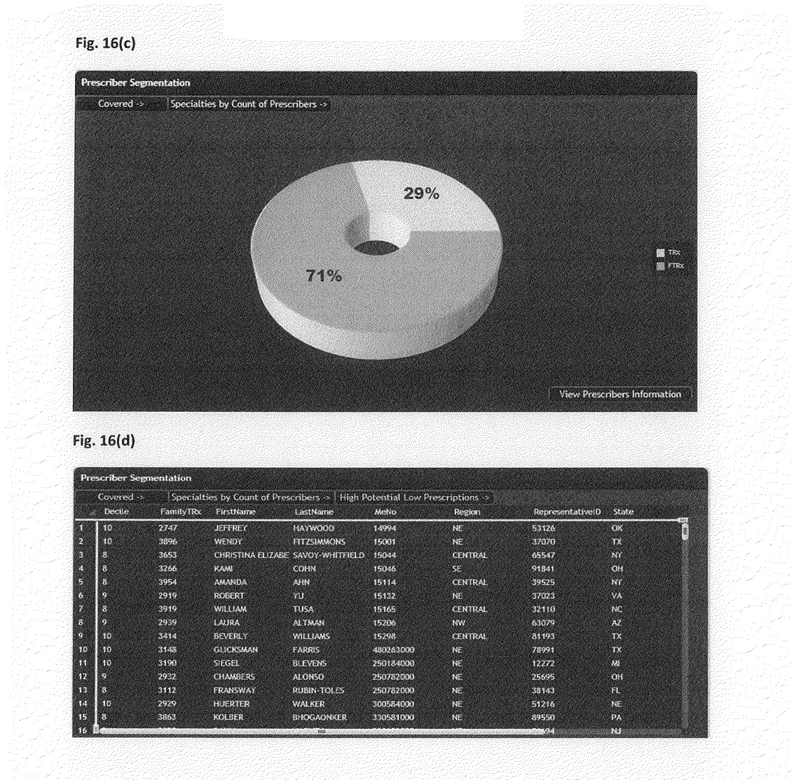

FIGS. 16(a)-16(d) are exemplary views depicting the prescriber segmentation predictive analytic algorithm. This algorithm is with respect to the covered geography in a pie chart, as in FIG. 16(a). Upon selecting the covered pie slice, a bar chart with specialties on X-axis and prescribes count on Y-axis is provided, as shown in FIG. 16(h). Specialties which have the high prescriber count are taken into consideration, they are:
DERMATOLOGY
FAMILY MEDICINE
NURSE PRACTITIONER
INTERNAL MEDICINE
OBSTETRICS/GYNECOLOGY
PEDIATRICS
PHYSICIAN ASSISTANT

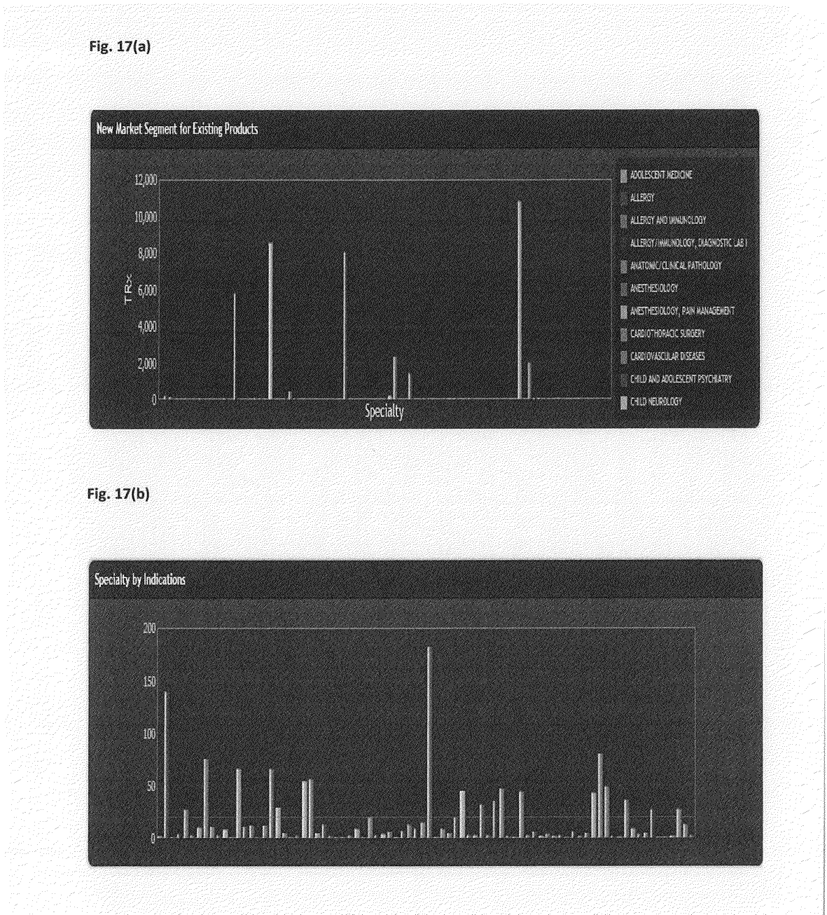

Upon selecting a specialty or a range of specialties, a pie chart for actual FTRx and product TRx is displayed, as shown in FIG. 17(c). Prescriber Information along with the product TRx, FTRx and stored values in a grid may also be displayed, as in FIG. 16(d).

FIGS. 17(a)-17(b) are exemplary views depicting the new market segment for existing products predictive analytic algorithm. For this Algorithm, the specialty to TRx is considered in FIG. 17(a). On the X-axis are the specialties and the TRx are on the Y-Axis. From the above chart, we consider the specialty having the high TRx values. The specialties having the high TRx values are indicated by 1 and the chart is displayed with the specialty indications having 0 on X-axis and TRx on Y-Axis, as shown in FIG. 17(b).

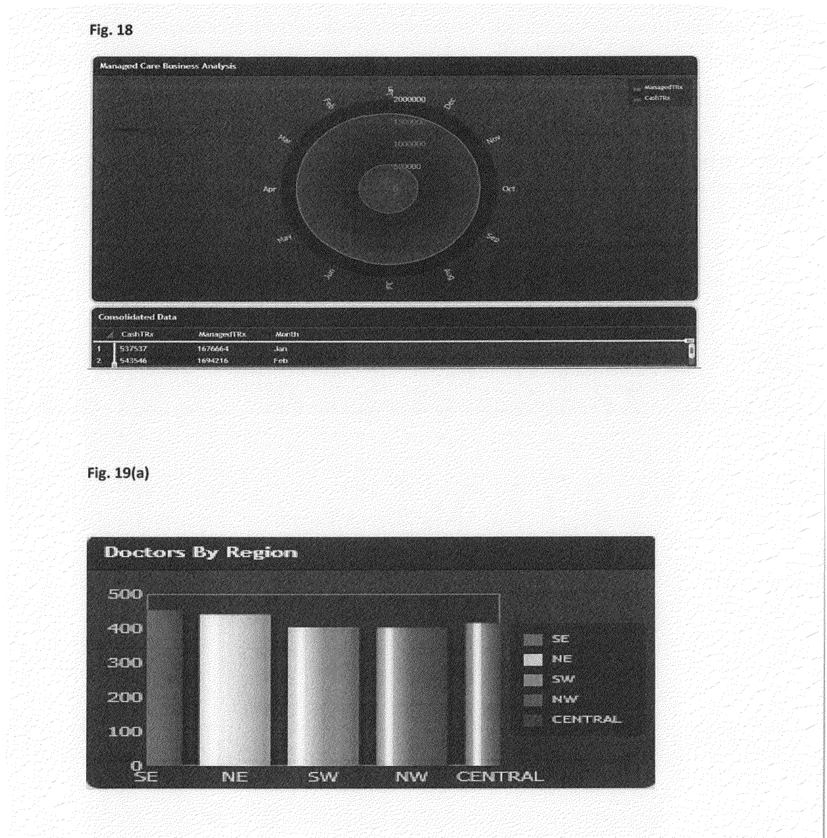

FIG. 18 is an exemplary view depicting the managed care business analysis predictive analytic algorithm. The chart displayed is a Radar Chart. The analysis is on the Month-wise Payer Details by Product. The Inner Radius denotes the Cash TRx Data Points and the Outer Radius depicts the Managed TRx for the Months.

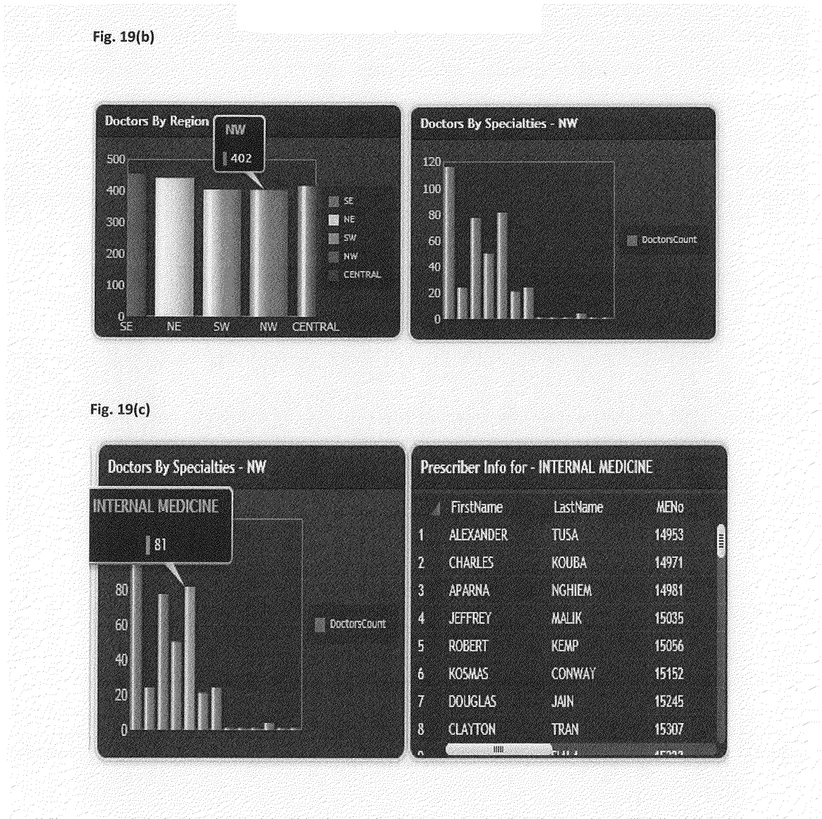

FIGS. 19(a)-19(d) are exemplary views depleting the market expansion (decision support) predictive analytic algorithm. This Algorithm relates a decision support algorithm that plots the FTRx and TRx values with TRx on X-Axis and FTRx on Y-Axis as a Scatter Chart, as shown in FIG. 19(a).

Upon selecting a range in the Quadrant that is indicated, the doctors by regions—NE, NW, CENTRAL, SB, and SW are displayed, as shown in FIG. 19(b). Clicking on any of the region on the bar displays the doctors by specialties in the selected region, as shown in FIG. 19(c). Selecting a specialty from the bar chart displays the list of prescribers in a grid.

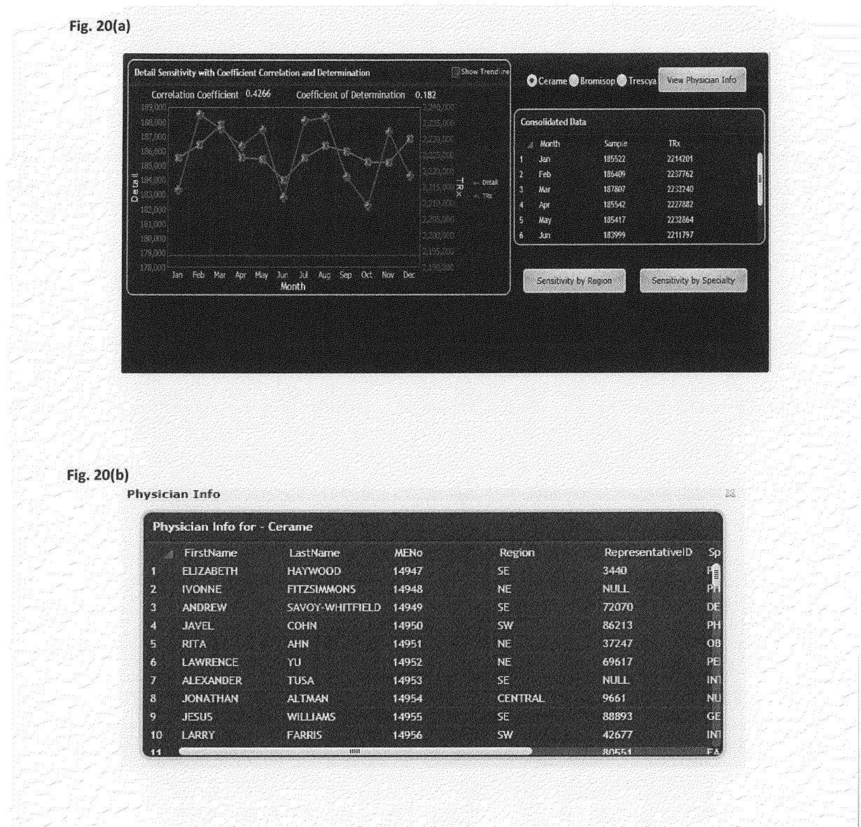

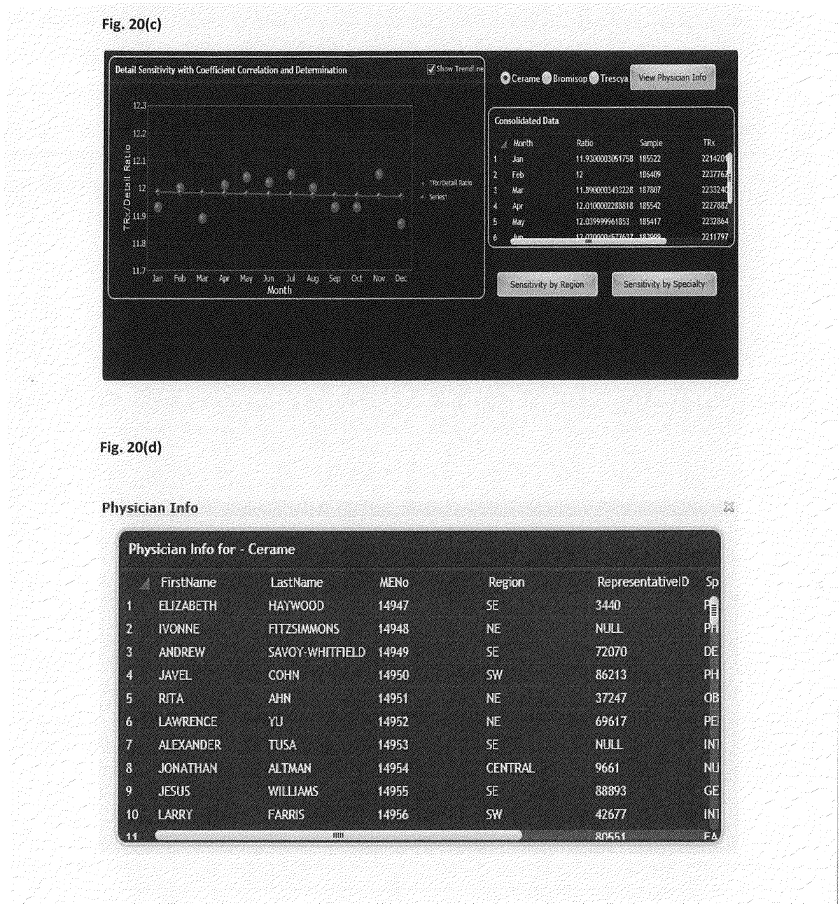

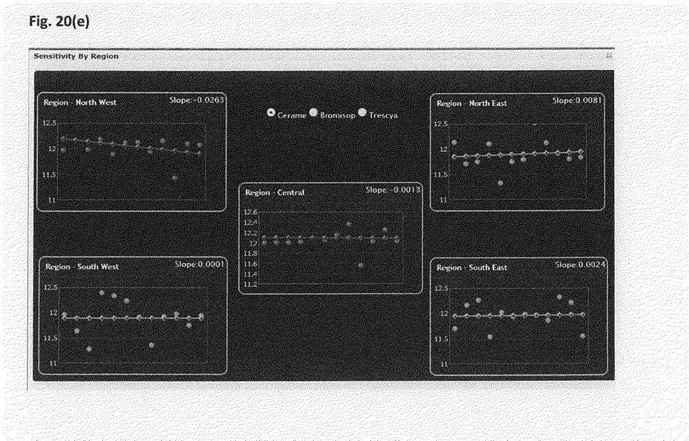

FIGS. 20(a)-20(e) are exemplary views depicting the detail sensitivity with coefficient correlation and determination predictive analytic algorithm. This algorithm explains the calculation of the coefficient of determination and correlation coefficient for detail and TRx. As depicted in FIG. 20(a), a graph is displaced with months on the X-axis and TRx on Y-axis, and also the correlation coefficient and coefficient of determination values displaced. The “Show Trend line” check box will show/hide the trend line. Also displayed are the consolidated data for month wise decile and TRx values.

Selecting the provided view physician info button and selecting a product from the product option menu will list physician info details in a grid format, as shown in FIG. 20(b). The show trend line check box displays the trend line for TRx/detail ratio. A graph is displayed with Months on the X-axis and TRx/Detail ratio on the Y-axis, and also displayed is the consolidated data for trend line, as shown in FIG. 20(c).

Selecting the “View Physician Info” button and selecting a product from the product option menu will list Physician Info details in a grid format, as presented in FIG. 20(d). Selecting the “Sensitivity by region” button displays the trend lines and Slope values for each of the regions—NW, NE, CENTRAL, SW, SE in a separate window for the selected product, as shown in FIG. 20(e). Selecting the “Sensitivity by Specialty” button displays the trend line for all specialties in the region which has negative slope value and also the corresponding data on the grid.

There is also a US map predictive analytic algorithm, which is not depicted in the Figures. Upon selecting the US Maps Algorithm, the USA Continental Map is displayed, with the total TRx within the deciles of different States in USA. In one embodiment, a pop up is displayed while the mouse is hovered on each State, displaying the state name and TRx in that state. Color gradients are applied to the States. For example, the states having the high TRx may be displayed with a dark color and the color gradually lightens to the states having the low TRx values.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A computerized system for performing business analytics, the system comprising:
a computer interface operating on a user's computer device, the computer device further comprising a processor and associated computer memory, a display and one or more input device, the computer device in communication with one or more computer database, the processor and memory configured to provide the interface for the user to access the computer database;
the processor and memory further configured to perform the steps of:
accepting input instructions from the input device to access information from one or more database;
accepting input from the input device providing instruction to perform business analytics;
performing business analytics; and,
displaying on the display device the results of the performed business analytics.

2. The computerized system according to claim 1, wherein the computer device is a mobile computing device.

3. The computerized system according to claim 2, wherein the mobile computing device is selected from the group consisting of: a smartphone, a tablet computer, and a notebook computer.

4. A computerized system for performing predictive analytics, the system comprising:
a computer interface operating on a user's computer device, the computer device further comprising a processor and associated computer memory, a display and one or more input device, the computer device in communication with one or more computer database, the processor and memory configured to provide the interface for the user to access the computer database;
the processor and memory further configured to perform the steps of:
accepting input instructions from the input device to access information from one or more database;
accepting input from the input device providing instruction to perform a predictive analysis using information accessed from the one or more database;
performing a predictive analysis algorithm; and,
displaying on the display device the results of performing predictive analysis.

5. The computerized system according to claim 4, wherein the computer device is a mobile computing device.

6. The computerized system according to claim 5, wherein the mobile computing device is selected from the group consisting of: a smartphone. a tablet computer, and a notebook computer.

7. The computerized system according to claim 4, wherein the predictive analysis algorithm is sample sensitivity with coefficient correlation and determination.

8. The computerized system according to claim 4, wherein the predictive analysis algorithm is a tree map algorithm.

9. The computerized system according to claim 4, wherein the predictive analysis algorithm is coverage analysis.

10. The computerized system according to claim 4, wherein the predictive analysis algorithm is targeting by payer or plan type.

11. The computerized system according to claim 4, wherein the predictive analysis algorithm is prescriber segmentation.

12. The computerized system according to claim 4, wherein the predictive analysis algorithm is new market segment tor existing products.

13. The computerized system according to claim 4, wherein the predictive analysis algorithm is managed care business analysis.

14. The computerized system according to claim 4, wherein the predictive analysis algorithm is market expansion.

15. The computerized system according to claim 4, wherein the predictive analysis algorithm is detail sensitivity with coefficient correlation and determination.

16. The computerized system according to claim 4, wherein the predictive analysis algorithm is mapping.

17. A method for performing business analytics comprising:
operating a computer interface on a user's computer device, the computer device further comprising a processor and associated computer memory, a display and one or more input device, the computer device in communication with one or more database, the processor and memory configured to provide the interface tor the user to instruct the processor to perform the steps of:
accepting input instructions from the input device to access information from one or more database;
accepting input from the input device providing instruction to perform business analytics;
performing business analytics; and,
displaying on the display device the results of the performed business analytics.

18. The method according to claim 17, wherein the computer device is a mobile computing device.

19. A method for performing predictive analytics comprising:
operating a computer interface on a user's computer device, the computer device further comprising a processor and associated computer memory, a display and one or more input device, the computer device in communication with one or more database, the processor and memory configured to provide the interface for the user to instruct the processor to perform the steps of:
accepting input instructions from the input device to access information from one or more database;
accepting input from the input device providing instruction to perform a predictive analysis using information accessed from the one or more database;
performing a predictive analysis algorithm; and,
displaying on the display device the results of performing predictive analysis.

20. The method according to claim 19, wherein the predictive analysis algorithm is selected from the group consisting of: sample sensitivity with coefficient correlation and determination, tree map algorithm, coverage analysis, targeting by payer or plan type, prescriber segmentation, new market segment, for existing products, managed care business analysis, market expansion, detail sensitivity with coefficient correlation and determination, and mapping.
